(19) United States
(12) Patent Application Publication
(10) Pub. No.: US 2021/0069844 A1
(43) Pub. Date: Mar. 11, 2021

(54) Dust-Proof Drilling Apparatus and Method

(71) Applicant: Toan Van LUU, Ho Chi Minh City (VN)

(72) Inventor: Toan Van LUU, Ho Chi Minh City (VN)

(73) Assignee: TON DUC THANG UNIVERSITY

(21) Appl. No.: 15/135,490

(22) Filed: Apr. 21, 2016

(51) Int. Cl. B23Q 11/00; B23B 45/00

(52) U.S. Cl. CPC B23Q 11/0071; B23B 2270/62; B23B 45/003; B23Q 11/0046

(57) ABSTRACT

A dust-proof drilling apparatus and method are disclosed which includes a body having a motor, a drill bit, a handgrip, and a power switch; an air suction unit, directly connected to the front of the body, designed to create an axial flow of air from the drill bit toward the body; and a dust collecting unit, directly and removably connected to the front of the air suction unit, designed to collect dusts and materials from the drilling operation of the drill bit, wherein the body, the air suction unit, and the dust collecting unit are connected sequentially along the axis of the drill bit.

### FIELD OF THE INVENTION

This is a patent related to a drilling apparatus. More particularly, this patent relates to a drilling apparatus having the capability to eliminate dust and unwanted debris.

### BACKGROUND ART

The using of drilling or milling machines on materials such as stone, stucco, wood, iron, etc. Scatters a large amount of dust and/or debris into the air. This is dangerous to a user because dust and debris can enter into the user's eyes and lungs, creating a hazardous environment for the user. In addition, the aftermath of a drilling, milling, or cutting operation usually leaves a messy working area full of dust and debris. The user must clean up after each use. Thus, there is a need for a drilling, milling, or cutting apparatus that does not create such problems.

There are many attempts to solve this problem. In one exemplary prior art drilling tool described in a U.S. Pat. No. 9,073,161 by Tseng, a bellows is attached in front of the drilling tool and covers the drill bit to collect dust and debris. However, the Tseng drilling tool is not effective because fine dusts can escape the bellow attachment at the contact point. In addition, in Tseng drilling tool does not have sufficient dust extracting force to prevent dust and debris from escaping into the surrounding air.

In other prior art drilling tool disclosed in a U.S. Patent Publication No. US-2005/0268427 to Britz, a lateral attachment is attached to the drilling tool in order to create an additional dust extracting force during the drilling operation. However, Britz drilling tools are still ineffective and cumbersome because the drill bit is not covered. As the drill bit is not covered, dust and debris follow the drill bit's grooves to escape into the surrounding area. In addition, lateral attachment still does not create an optimal dust extracting force while adding weight and rendering the Britz type drilling tool cumbersome to use.

Therefore, there is a need for a simple, easy to use, and effective drilling apparatus that can completely eliminate dust and debris from entering into the proximal area of a user that may cause short-term and long-term harms to a user.

The dust-proof drilling apparatus of the present invention meet the above requirements.

### SUMMARY OF THE INVENTION

Accordingly, an objective of the present invention is to provide a dust-proof drilling apparatus and method are disclosed which includes a body having a motor, a drill bit, a handgrip, and a power switch; an air suction unit, directly connected to the front of the body, designed to create an axial flow of air from the drill bit toward the body; and an dust collecting unit, directly and removably connected to the front of the air suction unit, designed to collect dusts and materials from the drilling operation of the drill bit, wherein the body, the air suction unit, and the dust collecting unit are connected sequentially along the axis of the drill bit.

Yet another objective of the present invention is to provide a method of dust-proof drilling, which includes the steps of placing a drill bit at the target location to be drilled, starting the drill motor to drill, creating an air suction in an axial direction to the drill bit, and collecting dust and/or debris in a dust collecting unit placed in the axial direction to the drill bit.

These and other advantages of the present invention will no doubt become obvious to those of ordinary skill in the art after having read the following detailed description of the preferred embodiments, which are illustrated in the various drawings and figures.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a diagram illustrating a perspective view of a dust-proof drilling apparatus in accordance with an embodiment of the present invention;

FIG. 2 is an exploded view of the dust-proof drilling apparatus of FIG. 1 in accordance with an embodiment of the present invention;

FIG. 3 is an exploded view of the air suction unit in accordance with an embodiment of the present invention;

FIG. 4 is an external view showing the dust-proof drilling apparatus with a dust collecting unit attached to an air suction unit in accordance with an embodiment of the present invention;

FIG. 5. Is internal view showing the dust-proof drilling apparatus with a dust collecting unit attached to an air suction unit in accordance with an embodiment of the present invention;

FIG. 6 is a diagram illustrating the operation of a dust-proof drilling apparatus in accordance with an embodiment of the present invention;

FIG. 7 is a diagram illustrating a method of dust-proof drilling in accordance with an embodiment of the present invention;

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

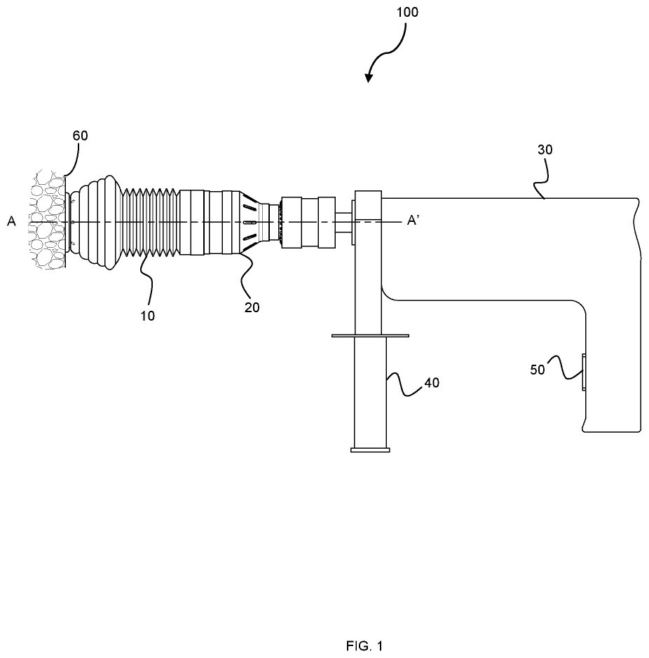

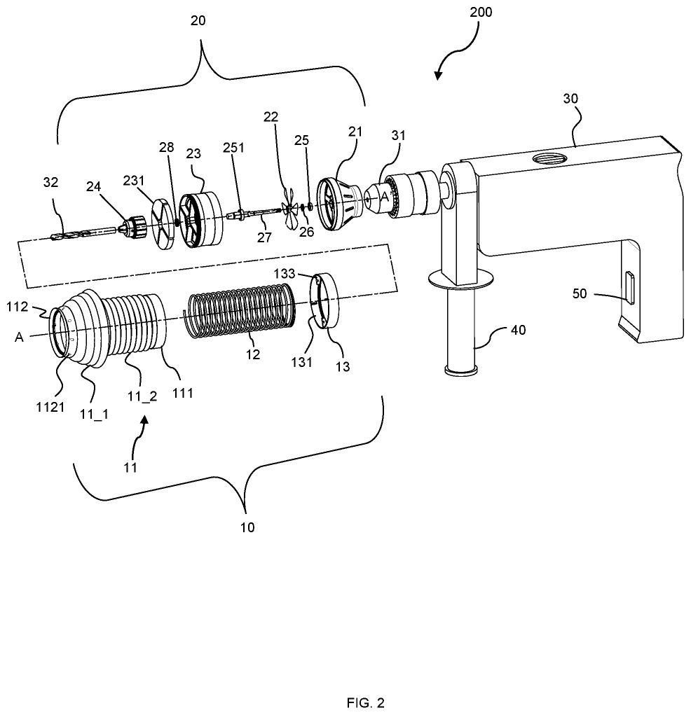

Now referring to FIG. 1, a perspective view of a dust-proof drilling apparatus 100 in accordance with an embodiment of the present invention is illustrated. In one preferred embodiment, dust-proof drilling apparatus 100 is an electrical drill tool includes a body 30 having a motor (not shown), a drill bit 32 (not shown in FIG. 1 but is shown in FIG. 2), a handgrip 40, and a power switch 50. However, the present invention is not limited only to electrical drilling apparatuses, body 30 can be a hand drill, boring, milling machines. The description and components of such apparatuses are well known in the art and thus will not be discussed here. Dust-proof drilling apparatus 100 also includes an air suction unit 20 directly connected to the front end of body 30 along the AA′ axis. A dust collecting unit 10 is directly and removably connected in front of air suction unit 20.

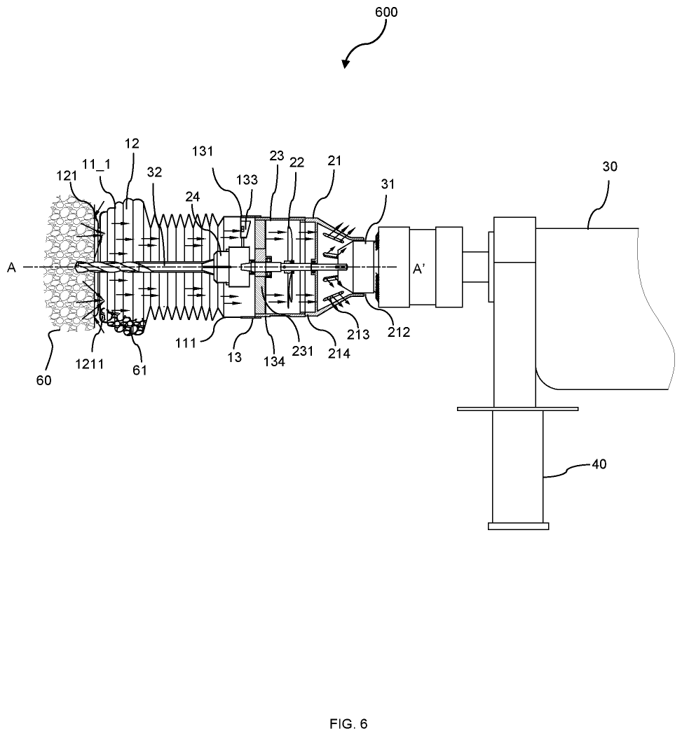

As shown in FIG. 1 of the present invention, dust collecting unit 10, air suction unit 20, and body 30 are connected in such sequence in a straight line with drill bit 32. Better illustrations of the sequential arrangement of dust-proof drilling apparatus 100 will be shown later in FIG. 2 of FIG. 6. As their names suggest, dust collecting unit 10 covers a work area 60 and functions to collect dusts and unwanted materials from drilling operations. Inside dust collecting unit 10, air suction unit 20 creates an axial air flow from work area 60 toward body 30 as drill bit 32 rotates. Consequently, dusts and unwanted materials are drawn into dust collecting unit 10 and a dust free working environment is achieved.

Next, referring now to FIG. 2, an exploded view 200 of dust-proof drilling apparatus 100 is illustrated. In one embodiment, air suction unit 10 includes a bellow cup 11 having a front end and a back end. In the preferred embodiment, bellow cup 11 has a first bellow section 11_1 and a second bellow section 11_2. First bellow section 11_1 has a conical shape, having a minimum diameter and a maximum diameter while second bellow section 11_2 has a cylindrical shape with a constant diameter equaled to the minimum diameter of first bellow section. At the center, bellow cup 11 has a large through hole so that drill bit 32 at any size can be used. In one embodiment, air suction unit 10 is made of either one of the following materials acrylonitrile butadiene styrene (ABS), polypropylene (PP), and polyethylene (PE).

Continuing with FIG. 2, an extracting ring 112 is placed at the front of bellow cup 11 to cover up work area 60. In one embodiment, extracting ring 112 has a curved shape and is made of hard material such as metal or hard plastic so that dusts and unwanted materials cannot escape. In addition, a plurality air inlet apertures 1121 are deposited around the outer periphery of extracting ring 112. In the back end of bellow cup 11, second bellow section 11_2 ends with a support base 111. A helical spring 12 is inserted inside bellow cup 11. A connecting ring element 13 is mated with support base 111 to keep helical spring 12 therein, and to connect with air suction unit 20 by means of a threaded back section 134. In one embodiment, connecting ring element 13 has a plurality of spring stoppers 133 projecting from the inside. There are rims or spaces 131 and 132 before and after spring stoppers 133 so that connecting ring 13 can mate with bellow cup 11 and air suction unit 20.

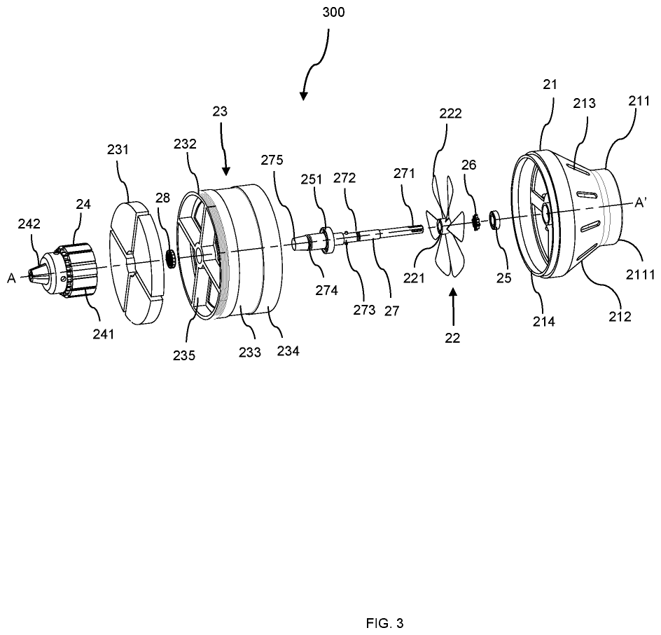

Next, referring to FIG. 2, dusting collecting unit 10 with the components described above, drill bit 32 and a drill bit holder 24, air suction unit 20, a drill chuck 31, and body 50 are connected sequentially in that order in the same axis AA′ with drill bit 32. Consequently, drill bit 32 and drill bit holder 24 are not directly connected to drill chuck 31 as in prior art drilling machines. In the preferred embodiment of the present invention, drill bit 32 and drill holder 24 are connected directly to the front of air suction unit 20. The components of air suction unit 20 will be discussed in detail in the FIG. 3.

Now referring to FIG. 3, an exploded view 300 of air suction unit 20 is illustrated. Air suction unit 20 includes a back adaptor 21 snugly connected to drill chuck 31, a front adaptor 23 is threadedly connected to back adaptor 21 and to dust collecting unit 10. At the heart of air suction unit 20 is a propeller 22 having a plurality of blades 222 projecting out of a tubular base 221. A plurality of blades 222 is designed so that when dust-proof drilling apparatus 100 is turned on, a plurality of blades 222 are simultaneously put into rotation, which creates an extracting air current from drill bit 32 to the body 30 along axis AA′. An air filter 231 is placed in front of front adaptor 23 but behind a drill bit holder 24 having a jaw 242. All of these components have through holes and connected together by a propeller shaft 27.

Continuing with FIG. 3, in one embodiment, back adaptor 21 has a conical section 212 having a maximum diameter and a minimum diameter, and an insertion sleeve 211 having a diameter equal to the minimum diameter of conical section 212. A back insertion sleeve 211 has an elastic cushion element 2111 covering the inner periphery of sleeve 211 for snugly and removably connecting to drill chuck 31. A plurality of air outlet apertures 213 deposited around the outer circumference of conical section 212. In front of conical section 21 is a front threaded sleeve 214. Front adaptor 23 has a front threaded section 232, a middle section 233 substantially hollow, and a rear threaded section 234. Rear threaded section 234 is screwed to front threaded section 214 of conical section 212 while front threaded section is screwed to threaded back section 134 of connecting ring 13. Threaded front section 232 is designed to threadedly engage with air suction unit 10. Middle section 233 is substantially empty for housing, propeller 22. Rear threaded section 234 is screwed to front threaded section 214.

Still referring to FIG. 3, in one embodiment, in the front, propeller shaft 27 is designed to include a front coupling tube 275 and operative to connect to drill bit holder 24. Front coupling tube 275 has a first threaded section 274 for threadedly engaging with a second threaded lock nut 28. A first bearing 251 and a second bearing 25 are used to bias propeller 22 in a fixed location during the operation of dust-proof drilling apparatus 100. After first bearing 251, a ball locking mechanism 273 is designed to prevent propeller 22 from rotating on propeller shaft 27. Next, a second threaded section 272 is threadedly connected to a first threaded lock nut 26. Finally, a plurality of locking grooves 271 is disposed in the axial direction of propeller shaft 27 for engaging with a drill chuck 31.

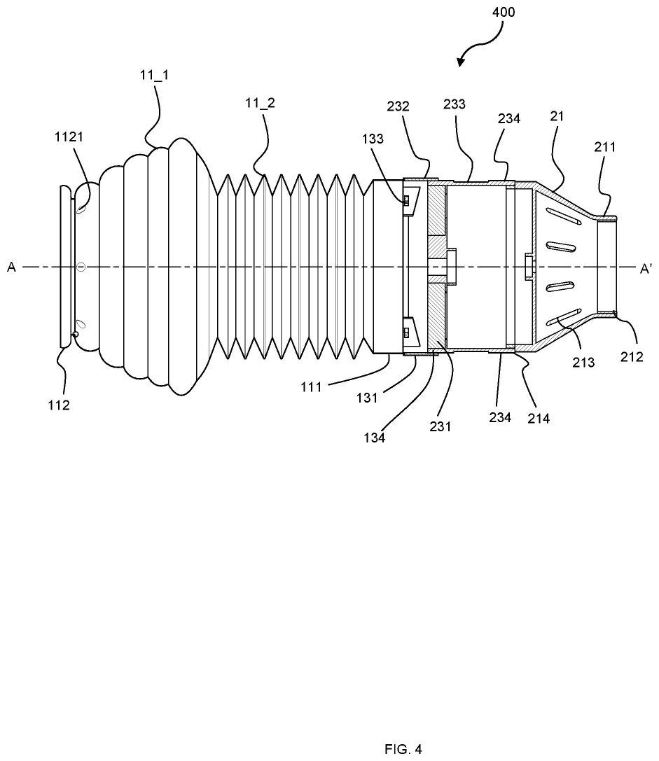

Now referring to FIG. 4, an external view 400 showing the dust-proof drilling apparatus 100 with dust collecting unit 10 attached to air suction unit 20 is illustrated. Dust collecting unit 10 is connected to air suction unit 20 by support base 111 screwed to threaded front section 232. Front adaptor 23 is screwed to back adaptor 21 at rear threaded section 234. Finally, air suction unit 10 is remarkably plugged to drill chuck 31 at sleeve 212.

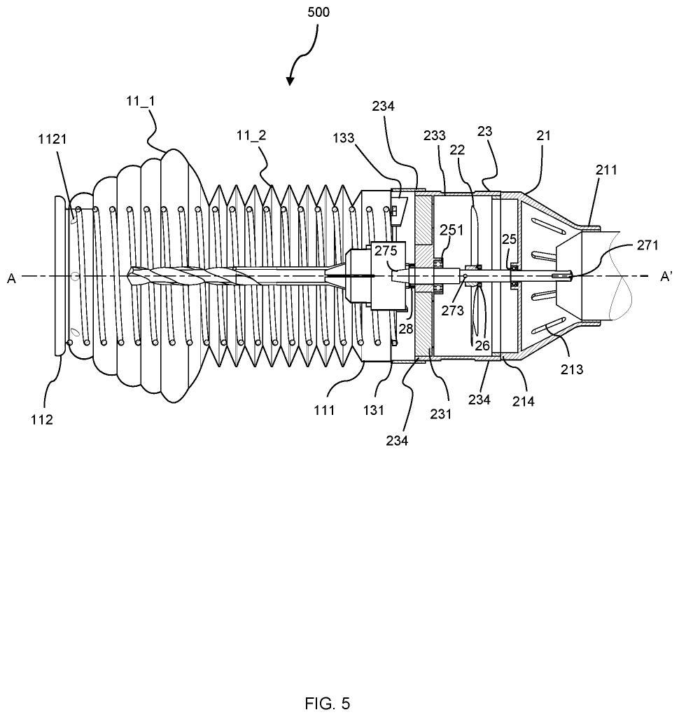

Now referring to FIG. 5, an internal view 500 showing the dust-proof drilling apparatus 100 with dust collecting unit 10 attached to an air suction unit 20 is illustrated. Air suction unit 20 includes back adaptor 21 snugly connected to drill chuck 31. Back insertion sleeve 211 with elastic cushion element 2111 covering the entire inner periphery of the back insertion sleeve 211 is snugly and removably connected to drill chuck 31. Propeller shaft 27 is connected to drill chuck 31 at locking grooves 271. First lock nut 26 and second lock nut 28 are used to hold propeller shaft 27 in position. First bearing 25 and second bearings 251 allow propeller shaft 27 to rotate around the axis AA′. Ball locking mechanism 273 locks propeller 22 from rotating around propeller shaft 27. This allows propeller 22 to rotate as propeller shaft 27 rotates. Propeller 22 is housed inside middle section 233. Air filter 231 is placed in front of front adaptor 23. A drill bit holder 24 with drill jaw 242 is connected to front coupling tube 275. There, drill jaw 242 firmly holds drill bit 32.

Next, referring to FIG. 6, a diagram 600 illustrating the operation of dust-proof drilling apparatus 100 in accordance with an embodiment of the present invention is presented. When the drill motor (not shown) is started, air suction unit 20 is set into rotation and generates an extracting air current represented by the arrows along the axial direction AA′. Initially, air enters into dust collecting unit 10 via a plurality of air inlet apertures 1121 disposed around the outer periphery of extracting ring 121. Accordingly, dust and/or debris 61 result from the drilling operation are extracted and collected at the bottom of bellow cup 11-1. Any fine dust carried by extracting air current pass first bellow section 11_1 are filtered out by air filter 231. Extracting air current exits dust-proof drilling apparatus 100 at plurality of air outlet apertures 213. When the drilling operation is completed, the user press power switch 50 again to stop the motor (not shown). At that moment, both propeller 22 and drill bit, 32 stop almost simultaneously and extracting air current also stops flowing. Dust and debris 61 is therefore settled at the bottom of first bellow section 11_1. Dust collecting unit 10 can be unscrewed easily from air suction unit 20 to empty dust and debris 61 from first bellow section 11_1. As described above, air suction unit 20 can be unplugged from drill chuck 31.

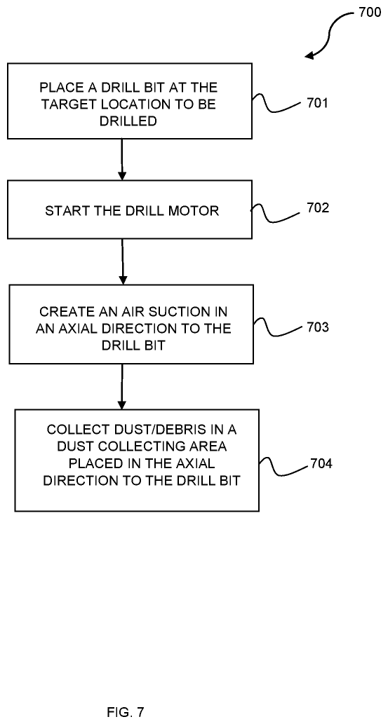

Finally, referring to FIG. 7, a flow chart illustrating a method 700 of drilling without causing dust or debris to scatter. In one embodiment, method 700 can be realized using dust-proof drilling apparatus 100 described above. However, method 700 of the present invention is not limited to the use of dust-proof drilling apparatus 100. Any drilling device using the steps of method 700 described herein is within the scope of the present invention. Method 700 includes the steps of placing a drill bit at the target location to be drilled, starting the drill motor to drill, creating an air suction in an axial direction to the drill bit, and collecting dust and/or debris in a dust collecting unit placed in the axial direction to the drill bit.

At step 701, a drill bit is aimed at a target location to be drilled.

At step 702, after the drill bit is placed at the target location, the drill motor is started. In one embodiment, step 701 and step 702 are realized by using dust-proof drilling apparatus 100 described above. Drill bit 32 is placed in work area 60 and power switch 50 is started.

Next, at step 703, as soon as the drill motor is started, create an air suction in the axial direction with the drill bit to draw dusts and debris toward the drill bit. In one embodiment, step 703 is realized by using air suction unit 20 of dust-proof drilling apparatus 100 described above. Air suction unit 20 is placed right before drill chuck 31. However, any drilling devices that create an air suction along the axial direction with the drill bit is within the scope of the present invention.

Finally, at step 704, collecting dusts and/or debris at a dust collecting unit attached in the axial direction with the drill bit. In one embodiment, step 704 is realized by using dust collecting unit 10 of dust-proof drilling apparatus 100 described above. Dust collecting unit 10 is placed right before air suction unit 20. In the preferred embodiment, drill bit 32 is not directly connected to drill chuck 31. Drill bit 32 is directly connected to air suction unit 20 to perform step 704.

The foregoing description details certain embodiments of the invention. It will be appreciated, however, that no matter how detailed the foregoing appears in the text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

### DESCRIPTION OF NUMERALS

10 dust collecting unit
11 bellow cup
11_1 first bellow section
11_2 second bellow section
111 support base
112 air inlet apertures
1121 extracting ring
12 helical spring
13 connecting ring
131 rim (space)
132 rim (space)
133 spring stoppers
134 threaded back section
20 air suction unit
21 back adaptor
211 back insertion sleeve
2111 elastic cushion element
212 conical section
213 air outlet apertures
214 front threaded sleeve
215 front bearing
22 fan (propeller)
221 tubular base
222 blades
23 front adaptor
231 air filter
232 front threaded section
233 middle section
234 rear threaded section
235 back bearing
24 drill bit holder
241 drill bit holder grooves
242 drill jaw
25 first bearing
251 second bearing
26 first threaded lock nut
27 propeller shaft
271 locking grooves
272 second threaded section
273 ball locking mechanism
274 first threaded section
275 front coupling tube
28 second threaded lock nut
30 body (of drill)
31 drill chuck
32 drill bit
40 handgrip
60 work area
61 dusts and unwanted materials
50 power switch

What is claimed is:

1. A dust-proof drilling apparatus, comprising:
a body comprising a motor, a drill bit, a handgrip, and a power switch for turning on or off said dust-proof drilling apparatus;
an air suction unit, directly connected to the front end said body, operative to create a flowing of air toward said body; and
a dust collecting unit, directly coupled to the front end said air suction unit, operative to collect dusts and other particles, wherein said body, said air suction unit, and said dust collecting unit are connected sequentially along the axis of said drill bit and wherein said drill bit is directly connected to said air suction unit.

2. The dust-proof drilling apparatus of claim 1 wherein said air suction unit further comprises:
a bellow cup having a front end and a back end;
a helical spring positioned inside said bellow cup; and
a connecting ring element connected to said back end of said bellow cup.

3. The dust-proof drilling apparatus of claim 2 wherein said bellow cup further comprises a first bellow section and a second bellow section, wherein said first bellow section has a conical shape, having a minimum diameter and a maximum diameter, said second bellow section has a cylindrical shape with a constant diameter equal to the minimum diameter of said first bellow section.

4. The dust-proof drilling apparatus of claim 3 wherein said first bellow section further comprises an extracting ring disposed in front of said first bellow section for contacting with a work area to be drilled, and wherein said extracting ring further comprises a plurality of air intake apertures disposed around the circumference of said extracting ring.

5. The dust-proof drilling apparatus of claim 3 wherein said second bellow section further comprises a support base located at the end of said second bellow section.

6. The dust-proof drilling apparatus of claim 3 wherein said dust collecting unit further comprises a connecting ring.

7. The dust-proof drilling apparatus of claim 6 wherein said connecting ring element further comprises:
a plurality of spring stoppers protruded from the internal periphery of said connecting ring element; and
a rear threaded section.

8. The dust-proof drilling apparatus of claim 1 wherein said air suction unit further comprises:
a back adaptor snugly connected to a drill chuck of said body of said dust-proof drilling apparatus;
a front adaptor threadedly connected to said back adaptor and said dust collecting unit;
a propeller having a plurality of blades projecting out from a tubular base and operative to create an axial air flow from said drill bit to said body;
an air filter positioned in front of said front adaptor;
an drill bit holder positioned in front of said air filter, operative to hold said drill bit; and
an propeller shaft connected to said propeller, said drill bit holder, and said drill chuck, operative to rotate with said drill bit.

9. The dust-proof drilling apparatus of claim 7 wherein said back adaptor further comprises a conical section having a maximum diameter and a minimum diameter, and a sleeve having a second diameter smaller than said minimum diameter.

10. The dust-proof drilling apparatus of claim 8 wherein said second section further comprises an elastic cushioning element deposited around the internal periphery of said sleeve.

11. The dust-proof drilling apparatus of claim 9 wherein said conical section further comprises an external threaded section.

12. The dust-proof drilling apparatus of claim 7 wherein said propeller shaft further comprises:
a front coupling tube operative to connect to said drill bit holder, said front coupling tube having a first threaded section;
a first bearing and a second bearing for maintaining said propeller in a fixed location during operation of said dust-proof drilling apparatus;
a ball locking mechanism, engaging and prevent said propeller from rotating on said propeller shaft;
a second threaded section; and
a plurality of locking grooves disposed in the axial direction of said propeller shaft for engaging with a chuck of said drilling apparatus.

13. The dust-proof drilling apparatus of claim 7 wherein said front adaptor further comprises:
a threaded front section for threadedly engaging with said air suction unit;
a middle section for containing said propeller therein; and
a rear threaded section for threadedly engaging with said back adaptor.

14. The dust-proof drilling apparatus of claim 7 wherein said air suction unit further comprises:
a first lock nut thirdly coupled to said first threaded section of said propeller shaft;
a second lock nut coupled to said second threaded section of said propeller shaft.

15. The dust-proof drilling apparatus of claim 1 wherein said dust collecting unit is made from a material consisting of acrylonitrile butadiene styrene (ABS), polypropylene (PP), and polyethylene (PE).

16. The dust-proof drilling apparatus of claim 1 wherein said body is made of a material consisting of plastic and steel and has a power between 450 to 480 watts and the drilling speed between 2500 to 4500 round per minute (RPM).

17. A method of dust-proof drilling using an electrical drilling apparatus, comprising:
placing a drill bit at a target location to be drilled;
starting drilling;
using the power of said electric drill bits, creating an air flow from said drill bit toward a body of said electrical drilling apparatus using a propeller positioned along the axial direction of said drill bit; and
using said air flow collecting dusts and/or debris to a dust collecting unit placed in the axial direction of said drill bit.

18. The method of claim 16 wherein said step of starting drilling further comprises turning on a power switch of said electrical drilling apparatus.

19. The method of claim 16 wherein said step of placing a drill bit at a location to be drilled further comprises placing said dust collecting unit including an extracting head over said location to be drilled.

20. The method of claim 18 wherein said dust collecting unit is positioned along the axis of said drill bit and is made of flexible, transparent plastic material consisting of acrylonitrile butadiene styrene (ABS), polypropylene (PP), and polyethylene (PE) so that a user can see said location to be drilled through said dust collecting unit.
